(19) United States
(12) Patent Application Publication
(10) Pub. No.: US 2015/0086783 A1
(43) Pub. Date: Mar. 26, 2015

(54) RESIN COMPOSITIONS FOR COATING SUBSTRATES TO IMPROVE SEALING PERFORMANCE

(71) Applicants: Henkel US IP LLC, Rocky Hill, CT (US); Henkel (China) Investment Co. Ltd., Shanghai (CN); Henkel AG & Co. KGaA, Duesseldorf (DE)

(72) Inventors: Shabbir Attarwala, Simsbury, CT (US); Viraj Kadam, Shanghai (CN); Qinyan Zhu, Cheshire, CT (US); Pradhyumna Ingle, Dewas M.P. (IN); Gregg Rossier, Martinsville, IN (US)

(21) Appl. No.: 14/556,786

(22) Filed: Dec. 1, 2014

Related U.S. Application Data
(63) Continuation of application No. PCT/US2013/043292, filed on May 30, 2013.
(60) Provisional application No. 61/652,996, filed on May 30, 2012.

(51) Int. Cl. C09J 163/00; B32B 37/12; C09J 5/00

(52) U.S. Cl. CPC C09J 163/00; C09J 5/00; B32B 37/12; C08K 3/38
USPC 428/355 EP; 524/405; 524/442; 156/330; 156/332; 156/330.9

(57) ABSTRACT

The present invention is directed to compositions useful for sealing substrates and substrates coated therewith. Additionally, methods of sealing and improving sealing performance using such compositions are provided.

### FIELD

The present invention provides compositions useful for sealing substrates and substrates coated therewith. Additionally, methods of sealing and improving sealing performance using such compositions are provided. Desirably, engine components, such as valve cover gaskets, coated with such compositions exhibit improved sealing performance as reflected by reduced emissions and increased engine efficiency.

### BACKGROUND

Substrates which suffer from surface imperfections or heat distortion create a poor quality seal. For example, a poor quality seal in engine valve cover gaskets leads to increased emissions and reduced engine efficiency, neither of which is desirable. Accordingly, there is a need for compositions which improve sealing performance of substrates contacted therewith, particularly engine valve cover gaskets.

### SUMMARY

The present invention provides compositions for improving sealing performance of substrates contacted therewith (e.g., a gasket and flange). Additionally, such compositions provide sufficient tackiness such that substrates contacted therewith remain affixed during the assembly process prior to curing of the composition thereby increasing efficiency of the assembly process. Advantageously, engine components coated with such compositions provide improved sealing performance thereby reducing emissions and increasing engine efficiency.

In one aspect, there is provided compositions including: (a) a curable component selected from an acrylate, a methacrylate, an epoxy resin, a benzoxazine resin, acrylonitrile, methacrylonitrile, vinyl acetate, or a combination of two or more thereof; and (b) a non-curable tackifying component.

The curable component (i.e. selected from an acrylate, a methacrylate, an epoxy resin, a benzoxazine resin, acrylonitrile, methacrylonitrile, vinyl acetate, or a combination of two or more thereof) may be present generally in amount of from about 50-95 percent, typically from about 60-80 percent, by weight of the total composition.

In another aspect, there is provided compositions including: (a) a curable component selected from an acrylate, a methacrylate, an epoxy resin, a benzoxazine resin, acrylonitrile, methacrylonitrile, vinyl acetate, or a combination of two or more thereof; and (b) a non-curable tackifying component including water and a material selected from sodium silicate, boric acid or combinations thereof.

In another aspect, the inventive compositions further include at least one thixotropic agent which is non-reactive.

In one aspect, the non-curable tackifying component is present in an amount to secure the gasket to a substrate prior to cure of the composition.

In another aspect, the non-curable tackifying component is present in an amount between about 5.0% by weight to about 50.0% by weight of the total weight of the composition.

In yet another aspect, the material in the tackifying component (e.g., material selected from sodium silicate, boric acid or combinations thereof) is present in an amount of about 10-50% by weight of the non-curable tackifying component, preferably about 10-40% by weight of the non-curable tackifying component.

The inventive compositions may also employ thixotropic agents. Non-limiting illustrations of useful thixotropic agents are various castor waxes, silica, fumed silica, clay, treated clay, a non-reactive polyamide oligomer, or silica gel treated with a silyl isocyanate, as well as those disclosed in, for example, U.S. Pat. No. 4,720,513, the disclosure of which is hereby incorporated in its entirety, or a combination of two or more such agents thereof. These thixotropic agents generally comprise about 10 to about 50% by weight, and typically from about 20 to about 40% by weight, of the total weight of the non-curable component. Naturally, a thixotropic agent should be present in amounts suitable and sufficient to effectuate its intended purpose. Non-limiting examples of suitable thixotropes include those available as: Aerosil from Degussa, Cabo-Sil TS 720 from Cabot, Castorwax from CasChem, Thixatrol and Thixcin from Rheox and Dislon from King Industries.

In one aspect, at least one thixotropic agent is a silica, a non-reactive polyamide oligomer or a combination of two or more thereof. In certain aspects, the curable component cures anaerobically.

In another aspect, the present invention provides substrates where at least part of a surface of the substrate is coated with a composition including:
a curable component selected from an acrylate, a methacrylate, an epoxy resin, a benzoxazine resin, or a combination of two or more thereof;
a non-curable tackifying component including water and a material selected from sodium silicate, boric acid or combinations thereof; and
optionally, a thixotropic agent.

In one aspect, the substrate is a gasket.

In one aspect, the substrate is a prefabricated gasket.

In another aspect, the substrate is a flange.

In yet another aspect, the substrate is an engine component.

In still another aspect, the substrate is constructed from cork, cardboard, fabric, graphite, metal, paper, metal, elastomer or a combination of two or more thereof.

In yet another aspect, the present invention provides methods for sealing including: (a) applying a coating of a composition including:
a curable component selected from an acrylate, a methacrylate, an epoxy resin, a benzoxazine resin, acrylonitrile, methacrylonitrile, vinyl acetate, or a combination of two or more thereof;
a non-curable tackifying component including water and a material selected from sodium silicate, boric acid or combinations thereof; and
optionally, a thixotropic agent;
   to at least part of a surface of a first substrate thereby forming a coated surface and (b) joining the coated surface to at least part of a surface of a second substrate. In one aspect, the first substrate is a gasket. In another aspect, the second substrate is a flange.

In yet another aspect, the present invention provides methods for sealing including: (a) applying a coating of a composition including:
a curable component selected from an acrylate, a methacrylate, an epoxy resin, a benzoxazine resin, or a combination of two or more thereof;
a non-curable tackifying component including water and a material selected from sodium silicate, boric acid or combinations thereof; and
optionally, a thixotropic agent;
   to at least part of a surface of a first substrate thereby forming a coated surface and (b) joining the coated surface to at least part of a surface of a second substrate. In one aspect, the first substrate is a gasket. In another aspect, the second substrate is a flange.

In yet another aspect, the methods provided further include allowing the composition to cure. In still another aspect, the gasket is constructed from cork, cardboard, fabric, graphite, metal, paper, metal, elastomer or combinations of two or more thereof In still yet another aspect, at least part of the surface of the first substrate is designed to engage at least part of the surface of the second substrate.

### DETAILED DESCRIPTION

Unless otherwise noted, the following terms carry the meaning indicated:

The term “(meth)acrylate” includes methacrylate as well as acrylate.

The term “(meth)acryloxy” includes methacryloxy as well as acryloxy.

The terms “cure”, “curable”, “curing” as used herein refer to a substantial change in state, condition or structure (physical and/or chemical) in a material as well as partial and complete curing.

The term “non-curable” means there is substantially no change in the state, condition or structure (physical and/or chemical) in the material.

The compositions of the present invention are formed by mixing the components together. In particular, the compositions of the present invention include
a curable component selected from an acrylate, a methacrylate, an epoxy resin, a benzoxazine resin, acrylonitrile, methacrylonitrile, vinyl acetate, or a combination of two or more thereof;
a non-curable tackifying component including water and a material selected from sodium silicate, boric acid or combinations thereof; and
optionally, a thixotropic agent.

Exemplary (meth)acrylates include a wide variety of materials represented by H₂C═C(G)CO₂R, where G may be hydrogen, halogen or alkyl of 1 to about 6 carbon atoms, and R may be selected from alkyl, cycloalkyl, alkenyl, cycloalkenyl, alkaryl, aralkyl or aryl groups of 1 to about 16 carbon atoms, any of which may be optionally substituted or interrupted as the case may be with silane, silicon, oxygen, halogen, carbonyl, hydroxyl, ester, carboxylic acid, urea, urethane, carbamate, amine, amide, sulfur, sulfonate, sulfone and the like.

Mono-, di- as well as tri-(meth)acrylates may be used. Illustrative (meth)acrylate compound may be a (meth)acrylate compound having a carbon-carbon double bond such as methyl(meth)acrylate, ethyl(meth)acrylate, butyl(meth)acrylate, isobutyl(meth)acrylate, 2-ethylhexyl(meth)acrylate, isooctyl(meth)acrylate, glycidyl(meth)acrylate, cyclohexyl(meth)acrylate, isobornyl(meth)acrylate, benzyl(meth)acrylate, 2-hydroxy(meth)acrylate, trimethoxybutyl(meth)acrylate, ethylcarbitol(meth)acrylate, phenoxyethyl(meth)acrylate, 2-hydroxyethyl(meth)acrylate, trimethylolpropanetri(meth)acrylate, tetramethylolmethane tetra(meth)acrylate, pentaerythritol hexa(meth)acrylate, pentaerythritol tetra(meth)acrylate, dipentadierythritol monohydroxy penta(meth)acrylate, dipentaerythritol hexa(meth)acrylate, 1,4-butyleneglycol di(meth)acrylate, 1,6-hexanediol di(meth)acrylate, polyethyleneglycol di(meth)acrylate, oligoester(meth)acrylate, and the like.

Non-limiting examples of specific (meth)acrylates include polyethylene glycol di(meth)acrylates, desirably triethyleneglycol di(meth)acrylate, hydroxypropyl (meth)acrylate, bisphenol-A di(meth)acrylates, such as ethoxylated bisphenol-A (meth)acrylate (“EBIPA” OR “EBIPMA”), and tetrahydrofuran (meth)acrylates and di(meth)acrylates, citronellyl acrylate and citronellyl methacrylate, hexanediol di(meth)acrylate (“HDDA” or “HDDMA”), trimethylol propane tri(meth)acrylate, tetrahydrodicyclopentadienyl (meth)acrylate, ethoxylated trimethylol propane triacrylate (“ETTA”), triethylene glycol diacrylate and triethylene glycol dimethacrylate (“TRIEGMA”).

In one aspect, the (meth)acrylate is anaerobically cured.

Suitable curable components for use in the present invention include Loctite® 515™ (60-100% polyurethane methacrylate resin, 5-10% amorphous, fumed, crystalline-free silica, 10-30% polyglycol dimethacrylate, 1-5% acrylic acid, 1-5% cumene hydroperoxide, 0.1-1% ethylene glycol, 0.1-1% 1-acetyl-2-phenylhydrazine and 1-5% saccharin), Loctite® 518™ (60-100% polyurethane methacrylate resin, 10-30% polyglycol dimethacrylate, 5-10% amorphous, fumed, crystalline-free silica, 1-5% acrylic acid, 1-5% cumene hydroperoxide, 1-5% ethylene glycol and 0.1-1% 1-acetyl-2-phenylhydrazine), Loctite® 534™ (60-100% polyurethane methacrylate resin, 10-30% polyglycol dimethacrylate, 5-10% thixotropic agent, 1-5% acrylic acid, 1-5% cumene hydroperoxide and 1-5% saccharin), Loctite® 620™ (60-100% 2-propenoic acid, 2-methyl-, (1-methylethylidene), 10-30% maleimide resin, 1-5% hydroxyalkyl methacrylate, 1-5% cumene hydroperoxide, 1-5% amorphous, fumed, crystal-free silica and 0.1-1% acetic acid, 2-phenylhydrazide) and Loctite® 2440™ (10-30% methacrylate ester, 1-5% amorphous, fumed silica, 10-30% polyglycol dioctanoate, 1-5% propylene glycol, 0.1-1% 1-acetyl-2-phenylhydrazine, 30-60% polyglycol dimethacrylate and 1-5% saccharin).

Typically, Loctite® 515™ and Loctite® 518™ are used as a form-in-place gasket, Loctite® 534™ is used as a tacking/dressing agent, Loctite® 620™is designed for the bonding of cylindrical fitting parts and Loctite® 2440™ is designed for the locking and sealing of threaded fasteners.

Exemplary epoxy resins include, but are not limited to, bisphenol A epoxy, bisphenol F diglycidyl ether, bisphenol A diglycidyl ether, 4-vinyl-1-cyclohexene diepoxide, butanediol diglycidyl ether, neopentylglycol diglycidyl ether, 3,4-epoxycyclohexylmethyl-3,4-epoxycyclohexanecarboxylate, limonene diepoxide, hexanediol diglycidyl ether, trimethylolpropane triglycidyl ether, aniline diglycidyl ether, diglycidyl ether of propylene glycol, cyanuric acid triglycidyl ether, ortho-phthalic acid diglycidyl ether, diglycidyl ester of linoleic dimer acid, dicyclopentadiene diepoxide, diglycidyl ether of tetrachloro bisphenol A, 1,1,1-tris(p-hydroxyphenyl)ethane glycidyl ether, tetra glycidyl ether of tetrakis(4-hydroxyphenyl)ethane, epoxy phenol novolac resins, epoxy cresol novolac resins, tetraglycidyl-4,4′-diaminodiphenylmethane, silanol-terminated polydiorganosiloxanes, or a combination of two or more thereof

Benzoxazines are generally the reaction products of an amine, a phenol and formaldehyde. A number of benzoxazine resins useful in the practice of the present invention are known in the art. For example, H. Ishada and T. Agag describe benzoxazines and their chemistry in Handbook of Benzoxazine Resins, 1st ed., Elsevier Publication (Reed Elsevier Company, New York, N.Y., 2011). See also, R. Tietze, “Benzoxazines”, The Fifth Triennial International Aircraft Fir and Cabin Safety Research (Oct.- Nov. 2007), as well as V. M. Russell et al, J. Appl. Polymer Sci., Vol. 70, pp. 1413-1425 (1998). Exemplary benzoxazine resins include, but are not limited to, XU3560, LMB6493, LMB6490 and LMB6492 (all available from Huntsman Corporation) and Epsilon 99110 and Epsilon 99120 (both available from Henkel Corporation), or a combination of two or more thereof

Generally, the curable component is added generally in an amount between about 50% by weight and about 95% by weight of the total composition.

Suitable non-curable tackifying components for use in the compositions of the present invention include an aqueous mixture and a material selected from sodium silicate, boric acid or combinations thereof In certain aspects, the material (i.e. material selected from sodium silicate, boric acid or combinations thereof) is present in an amount of about 10-50% by weight of the non-curable tackifying component. Generally, the non-curable tackifying component is added in an amount between 5.0% by weight and 50.0% by weight of the total composition. Some other useful tackifying agents and/or gums that can be incorporated in the compositions of this invention include MQ tackifier resin (available from Momentive Performance Materials-Silicones), terpene oligomer, coumarone/indene resin, aliphatic petrochemical resin and modified phenolic resin, e.g., as disclosed in U.S. Pat. No. 7,405,259, the entire contents of which are incorporated by reference herein, flouroalkylsilylated MQ resin, e.g., as disclosed in U.S. Pat. No. 7,253,238, the entire contents of which are incorporated by reference herein, silicone gum, e.g., flourosilicon gum, such tackifying agents/gums being utilized in known and conventional amounts.

Thus, in another aspect, there is provided compositions including: (a) a curable component selected from an acrylate, a methacrylate, an epoxy resin, a benzoxazine resin, acrylonitrile, methacrylonitrile, vinyl acetate, or a combination of two or more thereof; and (b) a non-curable tackifying component including an aqueous mixture and a material selected from sodium silicate, boric acid, MQ tackifier resin, terpene oligomer, coumarone/indene resin, aliphatic petrochemical resin, modified phenolic resin, silicone gum, and combinations thereof. Optionally, there could be at least one thixotropic agent described above present.

The compositions in accordance with the invention may optionally include, if so desired, one or more additives such as, for example, fillers, adhesion promoters, plasticizers, solvents, stabilizers (e.g. UV stabilizers), antioxidants, pigments, accelerators, curing agents, defoamers, viscosity modifiers, fragrances, biocides, biostats, preservatives, heat dissipating agents etc. Such additives are known to the person skilled in the art and should be present in an amount suitable to effectuate their intended purpose. For example, if such components are used, they may be used in amounts of up to about 25 weight %, more preferably up to about 10 weight %, and most preferably, up to about 5 weight %, based on a total weight of the composition.

If a filler is desired, fillers suitable for addition to the compositions of this invention may include, for example, fumed silica, precipitated silica and calcium carbonates. Treated calcium carbonates having particle sizes from about 0.07 μm to about 4 μm are particularly useful and are available under several trade names: Ultra Pflex, Super Pflex, Hi Pflex from Specialty in Minerals; Winnofil SPM, SPT from Zeneca Resins; Hubercarb lat, Hubercarb 3 Qt and Hubercarb W from Huber and Kotomite from ECC. These fillers can be used either alone or in combination. The fillers can comprise up to about 200 parts per 100 parts of the polymer component(s) with from about 80 to about 150 parts filler per 100 parts polymer being suitable for many adhesive applications.

If a plasticizer is desired, exemplary plasticizers may include phthalates, dipropylene and diethylene glycol dibenzoates and mixtures thereof, epoxidized soybean oil, and the like. Dioctyl and diisodecylphthalate are commercially available under the trade names Jayflex DOP and JayFlex DIDP from Exxon Chemical. The dibenzoates are available as Benzoflex 9-88, Benzoflex 50 and Benzoflex 400 from Velsicol Chemical Corporation. Epoxidized soybean oil is available from Houghton Chemical Corporation as Flexol EPO. The plasticizer can comprise up to about 100 parts of the polyurethane polymer with from about 40 to about 80 parts per hundred parts of polymer being satisfactory in many cases.

If a UV stabilizer and/or antioxidant is desired, such UV stabilizers and/or antioxidants can be incorporated into the compositions of this invention in an amount of from 0 to about 5 parts per hundred parts polyurethane polymer with from about 0.5 to about 2 parts providing generally good results. Exemplary materials are available from BASF Corporation under the trade names Tinuvin 770, Tinuvin 327, Tinuvin 213, Tinuvin 622 and Irganox 1010.

Adhesion promoters can be employed at levels of from about 0.5 to about 5 parts per hundred parts of the polymer compositions with from about 0.8 to about 1.5 parts per hundred parts polymer being especially advantageous. Suitable adhesion promoters include gamma-glycidoxypropyltrimethoxysilane, gamma-aminopropyltrimethoxysilane, N-beta-(aminoethyl)-gamma-aminopropyltrimethoxysilane, bis-(gamma-trimethoxysilylpropyl)amine, N-beta-(aminoethyl)-gamma-aminopropylmethyldimethoxysilane and tris-(gamma-trimethoxylsilyl)isocyanurate. Some that are commercially available include Silquest A-1120 silane, Silquest A-2120 silane, Silquest A-1170 silane and Silquest A-187 silane, all of which are available from Momentive Performance Materials.

If a solvent is desired, useful solvents include aromatic and aliphatic esters and ketones ranging in amounts of from 0 to 20, and preferably from 0 to 5, weight parts per 100 weight parts of the total composition. Some such solvents may also function as viscosity modifiers.

Suitable substrates include those constructed from cork, cardboard, fabric, graphite, metal, paper, metal, elastomer or a combination of two or more thereof. In one aspect, the substrate is a gasket including graphite.

The compositions of the present invention may be employed as a form-in-place gasket. Alternatively, the compositions of the present invention may be applied as a coating to a prefabricated gasket.

The compositions of the present invention may also be employed as a structural adhesive.

The invention may be further understood with reference to the following non-limiting examples.

### EXAMPLES

Exemplary compositions of the present invention include the following formulations. Exemplary Formulation “A” having a curable component including bisphenol A epoxy, a curing agent (e.g., ethyleneamine) and a non-curable tackifying component including an aqueous mixture of sodium silicate and/or boric acid. Exemplary Formulation “B” having a curable component selected from the group consisting of Loctite® 515™, Loctite® 518™, Loctite a® 534™ and Loctite® 620™; and a non-curable tackifying component including an aqueous mixture of sodium silicate and/or boric acid, for example, wherein the non-curable tackifying component includes 50% by weight of an aqueous mixture of sodium silicate or 50% by weight of an aqueous mixture of boric acid.

Additionally, exemplary substrates of the present invention include gaskets coated with the aforementioned compositions. In one particular aspect, the gaskets include graphite.

In accordance with the present invention, an exemplary composition was formed by mixing the components together. The exemplary composition was packaged in 300 ml LDPE red cartridges and stored at 38° C. for up to 8 weeks. The results of a packaging study conducted with this exemplary composition are summarized in Table 1.

TABLE 1

| QC/LMS TEST | STM | SPEC | INITIAL | 4 WKS | 8 WKS |
|---|---|---|---|---|---|
| Appearance | 1 | Yellowish | Pass | Pass | Pass |
| | | paste | | | |
| Viscosity, Physica C&P, MK22, at | 740 | | 47,760 | 46,750 | 49,050 |
| 5 sec-1 Pa · s | | | | | |
| Viscosity, Physica C&P, MK22, at | 740 | | 19,500 | 19,330 | 19,010 |
| 20 sec-1 Pa · s | | | | | |
| Br/Pr, 60 min RTC, TS239/240 ss | 754 | | 126/10.2 | 136/18.7 | 99/7.1 |
| nuts/bolts, as rec, pre-torqued to 44 | | | | | |
| in-lbs, in-lbs | | | | | |
| Br/Pr, 24 hr RTC, TS239/240 ss | 754 | | 267/73.5 | 277/69 | 251.55 |
| nuts/bolts, as rec, pre-torqued to 44 | | | | | |
| in-lbs, in-lbs | | | | | |

As reflected in Table 1, the exemplary composition remained stable with consistent performance at the time points measured, namely, initially, 4 weeks and 8 weeks following storage at 38° C.

Additionally, this exemplary composition was applied onto Briggs & Stratton W-14 engine heads with a roll attached to a 300 ml cartridge wherein usage was measured at around 0.6 gram per engine head. The engine heads were torqued to 210 in-lbs and cured at room temperature overnight (about 18 hrs). The engines were tested for leak, emission and temperature profile under different running conditions (i.e., 50% input load for 1 hr and 100% input load for 1 hr).

TABLE 2

| TEST | | | | |
|---|---|---|---|---|
| STEP | TEST CONDITION | SPEC | ENGINE #1 | ENGINE #2 |
| 1 | Leak test @ 70 psi after | Pass | Pass | Pass |
| | RTC ≧ 18 hrs | | | |
| 2a | Emission test after | ≦8% | 3% | 4% |
| | RTC ≧ 18 hrs, engine with | | | |
| | 50% input load for 1 hr | | | |
| 2b | Leak test @ 70 psi after | Pass | Pass | Pass |
| | RTC ≧ 18 hrs, engine with | | | |
| | 50% input load for 1 hr | | | |
| 3a | Emission test after | ≦8% | 4% | 9% |
| | RTC ≧ 18 hrs, engine with | | | |
| | 50% input load for 1 hr and | | | |
| | 100% input load for 1 hr | | | |
| 3b | Leak test @ 70 psi after | Pass | Foaming near | Leaking near |
| | RTC ≧ 18 hrs, engine with | | spark plug area | spark plug area |
| | 50% input load for 1 hr and | | with snoop | with snoop |
| | 100% input load for 1 hr | | | |
| 3c | HC + NOx | TBD | 5.46 | 5.45 |
| | (hydrocarbon and nitroxide), | | | |
| | g/hp hr | | | |
| 3d | Exhaust Temperature, ° F. | | 5557 | 583 |
| | @ 100% input Mode | | | |
| | Exhaust Temperature, ° F. | | 512 | 531 |
| | @ 75% input Mode | | | |
| | Exhaust Temperature, ° F. | | 455 | 462 |
| | @ 50% input Mode | | | |
| | Exhaust Temperature, ° F. | | 404 | 409 |
| | @ 25% input Mode | | | |
| | Exhaust Temperature, ° F. | | 395 | 390 |
| | @ 10% input Mode | | | |

As reflected in Table 2, the engines passed the initial leak test and the emission and leak test after 1 hr dynamic test at 50% input load. However, leaks were detected after the engines were run under 100% input load for 1 hr whereafter the engine heads were opened and the leaks path found in the area near combustion/sparkplug. Notably, the temperature at spark plug was up to 583° F., which was higher than the profile expected (around 480° F.). Thus, the exemplary composition is better suited for a lower temperature requirement as is found in the engine valve cover gasket. Likewise, other engines, such as Kohler engines wherein the engine head temperature is set around 480° F. are also suitable for use with such compositions.

1. A composition comprising:
(a) a curable component selected from an acrylate, a methacrylate, an epoxy resin, a benzoxazine resin, acrylonitrile, methacrylonitrile, vinyl acetate, or a combination of two or more thereof; and
(b) a non-curable tackifying component comprising water and a material selected from the group consisting of sodium silicate, boric acid or combinations thereof.

2. The composition of claim 1, further comprising at least one thixotropic agent which is non-reactive.

3. The composition of claim 1, wherein the non-curable tackifying component is present in an amount to secure the gasket to a substrate prior to cure of the composition.

4. The composition of claim 1, wherein the non-curable tackifying component is present in an amount between about 5.0% by weight to about 50.0% by weight of the total weight of the composition.

5. The composition of claim 1, wherein the material in said non-curable tackifying component is present in an amount of about 10-50% by weight of the non-curable tackifying component.

6. The composition of claim 2, wherein said at least one thixotropic agent is castor wax, silica, silica, fumed silica, clay, treated clay, a non-reactive polyamide oligomer, or silica gel treated with a silyl isocyanate, a silica, a non-reactive polyamide oligomer or a combination of two or more thereof.

7. The composition of claim 6, wherein said at least one thixotropic agent is a silica, a non-reactive polyamide oligomer or a combination of two or more thereof.

8. The composition of claim 2, wherein the thixotropic agent is present in an amount between about 10% by weight to about 50% by weight of the total weight of the non-curable component.

9. The composition of claim 1, wherein the curable component cures anaerobically.

10. A substrate wherein at least part of a surface of the substrate is coated with a composition of claim 1.

11. The substrate of claim 10, which is a prefabricated gasket.

12. The substrate of claim 10, which is a flange.

13. The substrate of claim 10, which is an engine component.

14. The substrate of claim 10, which is constructed from cork, cardboard, fabric, graphite, metal, paper, metal, elastomer or a combination of two or more thereof.

15. The substrate of claim 14, which is a gasket.

16. A method for sealing comprising:
(a) applying a coating of a composition of claim 1 to at least part of a surface of a first substrate thereby forming a coated surface and
(b) joining the coated surface to at least part of a surface of a second substrate.

17. The method of claim 16, wherein the first substrate is a gasket.

18. The method of claim 16, wherein the second substrate is a flange.

19. The method of claim 16, further comprising allowing the composition to cure.

20. The method of claim 17 wherein at least part of the surface of the first substrate is designed to engage at least part of the surface of the second substrate.
